(19) United States
(12) Patent Application Publication
(10) Pub. No.: US 2022/0241998 A1
(43) Pub. Date: Aug. 4, 2022

(54) ARCUATE OR CIRCULAR CUTTING AND/OR MARKING APPARATUS

(71) Applicant: Creator's Stained Glass, Inc., Spring Grove, IL (US)

(72) Inventors: Ray Nicholas, Ingleside, IL (US); Ryan Nicholas, Ingleside, IL (US)

(21) Appl. No.: 17/589,123

(22) Filed: Jan. 31, 2022

Related U.S. Application Data
(60) Provisional application No. 63/143,547, filed on Jan. 29, 2021.

(51) Int. Cl. B26D 1/12; B26D 3/08

(52) U.S. Cl. CPC B26D 1/125; B26D 3/085

(57) ABSTRACT

An arcuate or circular cutting and/or marking apparatus comprises a bridging element comprising legs engageable to a grid base, wherein the bridging element comprises a circular cutting and/or marking element extending from a bottom of the bridging element for cutting and/or marking material, and a rotary handle connected to the circular cutting and/or marking element extending from a top of the bridging element for rotating the cutting and/or marking element. Systems and methods of the same are further provided.

### CROSS-REFERENCE TO RELATED APPLICATIONS

The present invention claims priority to U.S. Prov. Pat. App. No. 63/143,547, titled “Arcuate or Circular Cutting and/or Marking Apparatus”, filed Jan. 29, 2021, which is incorporated herein by reference in its entirety.

### TECHNICAL FIELD

The present invention relates to an arcuate or circular cutting and/or marking apparatus. Specifically, the arcuate or circular cutting and/or marking apparatus comprises a bridging element comprising legs engageable to a grid base, wherein the bridging element comprises a circular cutting and/or marking element extending from a bottom of the bridging element for cutting and/or marking material disposed therebeneath, and a rotary handle connected to the circular cutting and/or marking element extending from a top of the bridging element for rotating the cutting and/or marking element. Systems and methods of the same are further provided.

### BACKGROUND

Glass cutters have been used for many years, if not centuries, for cutting glass panes into smaller pieces. Often, these glass pieces are used making artwork or other like works, where smaller pieces of glass are compiled together into a larger whole. For example, stained glass techniques typically utilize glass panes cut into specific shapes and tiled together to form imagery. Because glass is often transparent, semi-transparent, or at least translucent, light can shine therethrough, enhancing the qualities of the resultant work.

The ability to etch or score an arc into a pane of glass is also known, and there are several apparatuses that can do so. Typically, these apparatuses utilize a handle that rotates a glass cutting element to etch or score an arc into a pane of glass. If rotated fully 360 degrees, the apparatuses can etch a full circle into a glass pane.

However, heretofore, it is difficult to provide a clean arcuate cut into a pane of glass that is sufficient for breaking cleanly at the etch line. Often, glass panes do not break cleanly at etch lines, whether arcuate or straight, which may lead to jagged and sharp edges that can be dangerous to users and unsightly. Arcuate glass etches are particularly difficult to cleanly break cleanly at etch lines due to the arcuate nature of the etch line itself. Thus, an arcuate etch must be sufficiently deep in a glass pane to allow it to be broken cleanly after etching. A need, therefore, exists for an improved arcuate or circular glass etching apparatus. Specifically, a need exists for an improved arcuate or circular glass etching apparatus that provides a sufficiently deep and clean etch on a pane of glass so that the same may be cleanly broken at the etch line. More specifically, a need exists for an improved arcuate or circular glass etching apparatus that allows for a clean break at an etch line without creating jagged or dangerous edges thereof.

More specifically, known cutting apparatuses often do not provide sufficient leverage for a cutting or etching element to provide the deep and clean etch necessary. Often, the etching element extends from an arm that is rotated by a handle. In some embodiments, the handle is spring-loaded on an axis such that pressing down on the handle pushes the axis a holding element, thereby pressing the etching element into the glass. However, extending the etching element on its arm often makes it difficult to provide the sufficient leverage to properly etch the glass pane, leading to incomplete or insufficient etches. Moreover, the rotating handle often does not have sufficient rigidity in transferring the pressure from the handle to the etching element. Thus, a need exists for an improved arcuate or circular glass etching apparatus that provides significant leverage for sufficient glass pane etches. Likewise, a need exists for an improved arcuate or circular glass etching apparatus that allows a handle to rigidly apply the etch to the glass pane.

In addition, arcuate or circular cutting or etching elements often do not provide sufficient clearance for relatively large panes of glass for etching. In some cases, the apparatus itself must be held firmly on the glass pane itself, such as with suction cups or the like, but typically only relatively small arcs and circles can be etched into glass. Other apparatuses provide a base on which the glass pane sits, and the etching element extends above the base via legs or the like; however, the legs often interfere with large panes of glass which may not fit within the space created by the legs extending from the base, thereby limiting their application. A need, therefore, exists for an improved arcuate or circular glass etching apparatus providing significant clearance for relatively larger panes of glass. Likewise, a need exists for an improved arcuate or circular glass etching apparatus allowing for larger arcs or circles to be etched into glass panes.

Moreover, typical arcuate or circular glass etching apparatuses serve only one function: to etch an arc or a circle into a glass pane. However, in some circumstances, other functions may be needed, such as simply marking of a glass pane. Moreover, planar materials other than glass, such as, for example, paper, cardboard, plastic or like materials, may also be placed within the space such that the material may be arcuately or circularly marked or cut. Thus, a need exists for an improved arcuate or circular glass etching apparatus that may be utilized for other purposes than etching glass panes. Specifically, a need exists for an improved arcuate or circular glass etching apparatus that may allow for marking and or cutting of materials other than glass panes.

### SUMMARY OF THE INVENTION

The present invention relates to an arcuate or circular cutting and/or marking apparatus. Specifically, the arcuate or circular cutting and/or marking apparatus comprises a bridging element comprising legs engageable to a grid base, wherein the bridging element comprises a circular cutting and/or marking element extending from a bottom of the bridging element for cutting and/or marking material, and a rotary handle connected to the circular cutting and/or marking element extending from a top of the bridging element for rotating the cutting and/or marking element. Systems and methods of the same are further provided.

To this end, in an embodiment of the present invention, an arcuate or circular cutting apparatus is provided. The apparatus comprises a base comprising a plurality of cells in a grid arrangement, a first leg extending from the base, a second leg extending from the base, and a bridging element spanning from the first leg to the second leg; an axis disposed perpendicularly through the bridging element at about a midpoint of the bridging element; a handle rotatably connected to the axis over the bridging element; an arm extending from the axis beneath the bridging element, the arm comprising a carriage thereon having a glass etching element disposed beneath the carriage, the glass etching element configured to etch a glass pane positioned beneath the glass etching element on the base.

It is, therefore, an advantage and objective of the present invention to provide an improved arcuate or circular glass etching apparatus.

Specifically, it is an advantage and objective of the present invention to provide an improved arcuate or circular glass etching apparatus that provides a sufficiently deep and clean etch on a pane of glass so that the same may be cleanly broken at the etch line.

More specifically, it is an advantage and objective of the present invention to provide an improved arcuate or circular glass etching apparatus that allows for a clean break at an etch line without creating jagged or dangerous edges thereof.

In addition, it is an advantage and objective of the present invention to provide an improved arcuate or circular glass etching apparatus that provides significant leverage for sufficient glass pane etches.

Likewise, it is an advantage and objective of the present invention to provide an improved arcuate or circular glass etching apparatus that allows a handle to rigidly apply the etch to the glass pane.

Further, it is an advantage and objective of the present invention to provide an improved arcuate or circular glass etching apparatus providing significant clearance for relatively larger panes of glass.

Still further, it is an advantage and objective of the present invention to provide an improved arcuate or circular glass etching apparatus allowing for larger arcs or circles to be etched into glass panes.

Moreover, it is an advantage and objective of the present invention to provide an improved arcuate or circular glass etching apparatus that may be utilized for other purposes than etching glass panes.

Specifically, it is an advantage and objective of the present invention to provide an improved arcuate or circular glass etching apparatus that may allow for marking and or cutting of materials other than glass panes.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of an arcuate or circular glass cutting apparatus in an embodiment of the present invention.

FIG. 2 illustrates a top view of an arcuate or circular glass cutting apparatus with a glass pane in an embodiment of the present invention.

FIG. 3 illustrates a close-up perspective view of an arcuate or circular glass cutting apparatus with a user exerting pressure on a handle thereof in an embodiment of the present invention.

FIG. 4 illustrates a close-up perspective view of a handle and arm arrangement of an arcuate or circular glass cutting apparatus in an embodiment of the present invention.

FIG. 5 illustrates a reverse angle close-up perspective view of a handle and arm arrangement of an arcuate or circular glass cutting apparatus in an embodiment of the present invention.

FIG. 6 illustrates a close-up perspective view of a lengthened handle arrangement of an arcuate or circular glass cutting apparatus in an embodiment of the present invention.

FIG. 7 illustrates a close-up perspective view of a shortened handle arrangement of an arcuate or circular glass cutting apparatus in an embodiment of the present invention.

### DETAILED DESCRIPTION OF THE PRESENTLY PREFERRED EMBODIMENTS

The present invention relates to an arcuate or circular cutting and/or marking apparatus. Specifically, the arcuate or circular cutting and/or marking apparatus comprises a bridging element comprising legs engageable to a grid base, wherein the bridging element comprises a circular cutting and/or marking element extending from a bottom of the bridging element for cutting and/or marking material, and a rotary handle connected to the circular cutting and/or marking element extending from a top of the bridging element for rotating the cutting and/or marking element. Systems and methods of the same are further provided.

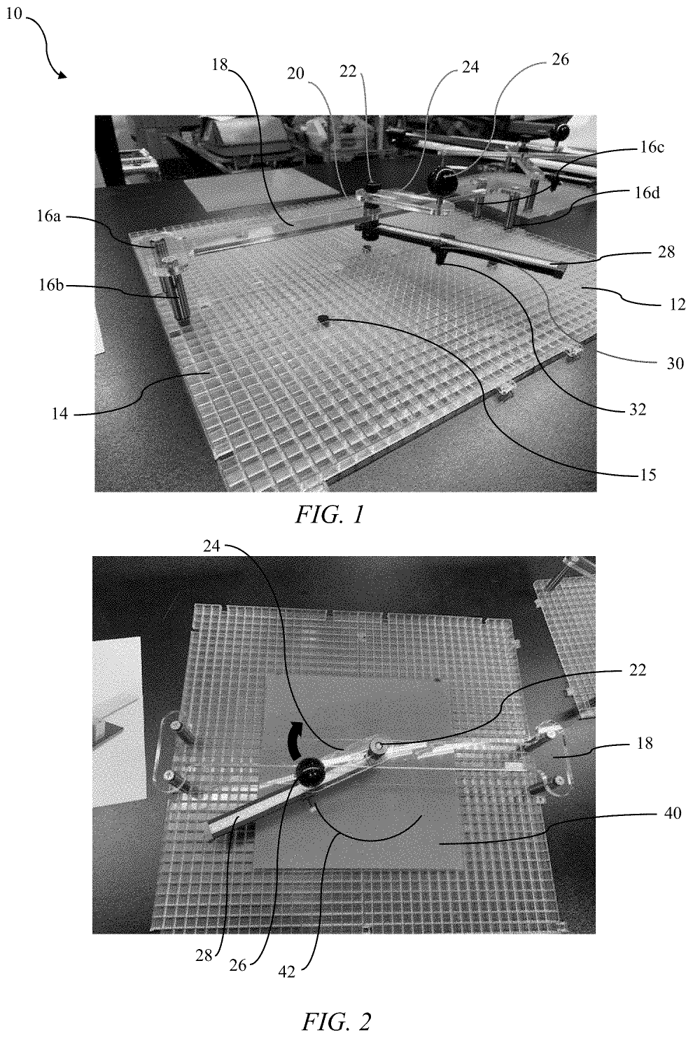

Referring now to the drawings, FIG. 1 illustrates an arcuate or circular glass pane etching apparatus 10 in an embodiment of the present invention. The apparatus 10 comprises a base 12 having a cellular grid system comprising a plurality of square cells 14 disposed therein. Seated within some of the square cells 14 are legs 16a, 16b, 16c, 16d. Legs 16a and 16b extend from the base 12 adjacent relatively close to one another on a first side of the base 12, and legs 16c, 16d extend relatively close to one another on a second side of the base 12. Extending from legs 16a, 16b to legs 16c, 16d is bridging element 18, spanning roughly the width of the base 12.

Specifically, legs 16a-16d may have feet, each of which extending from a bottom of each leg, respectively, and sized and shaped to fit within respective square cells 14. The feet may be frictionally held within the cells 14 thereby rigidly holding the legs 16a-16d in place and extended upwardly from the base 12. Preferably, the feet of each of the legs 16a-16d may be rigidly held within each respective cell, but may be removed so that each of the legs 16a-16d may be placed elsewhere on the base 12 within other cells 14. The feet may be square to match the shape of the cells 14, but may preferably be round and shaped like discs, so that the feet may be held within each of the cells no matter their orientation on the base 12. In addition, at various locations, one or more frictional elements 15 may be positioned in one or more cells 14 which may hold a glass pane in place when placed on the base 12 during an etching process, as described herein.

The bridging element 18 may be connected to the tops of each of the legs 16a-16b, thereby rigidly holding the bridging element 18 in place thereon. Optionally, the legs 16a-16d may have sleeves thereover that may rotate so that glass panes, as described below, may contact the legs and easily be moved, such as if a glass pane is being positioned for etching of the same.

The bridging element 18 may extend from legs 16a, 16b to legs 16c, 16d and be rigidly connected thereto via adhesive, screws, bolts, or other like connecting means. The bridging element 18 may be rigid, but may have a flex when pressed, especially when pressure is applied at roughly a midpoint 20 between legs 16a, 16b and legs 16c, 16d. Therefore, bridging element 18 may act as a leaf spring, allowing the bridging element to flex downwardly at roughly the midpoint 20, but may spring back to its original position when pressure is removed. Preferably, the bridging element 18 may be made from a polymeric material, such as acrylic, and may also preferably be transparent or at least semi-transparent or translucent so that a user may easily see therethrough from above.

Disposed at roughly the midpoint 20 between the legs 16a, 16b and legs 16c, 16d may be an axis 22 disposed perpendicularly through the bridging element 18 on which a handle 24 is connected on one end thereof on a top of the bridging element 18. A gripping element 26, such as a gripping ball, for example, may be disposed on an opposite end of the handle 24 for a user to hold. The handle 24 may therefore be rotated about the axis 22 via the gripping element 26, which may link with arm 28 extending from a bottom of the bridging element 18 through the axis 22. Thus, as the handle 24 rotates by a user gripping the gripping element 26 and turning the same, the arm 28 also rotates together with the handle 24 via the axis 22. Both the handle 24 and the arm 28 may rotate smooth due to roller bearings, preferably needle roller bearings, disposed between the handle 24 the top of bridging element 18 and between the arm 28 and the bottom of the bridging element 18.

A carriage 30 may be attached to the arm 28 and may further have a glass etching element 32 on a bottom thereof. Thus, a glass pane 40 (as shown in FIG. 2) may be placed beneath the arm 28, and may be contacted by the glass etching element 32. As the user, holding the gripping element 26, rotates the handle 24, the arm 28 rotates, thereby allowing the glass etching element 32 to etch or score an arcuate etch-line 42 into the glass pane 40. If completing a full 360-degree turn, the glass etching element 32 may etch a full circle into the glass pane 40. The glass pane may be removed and cleanly broken at the etch-line 42.

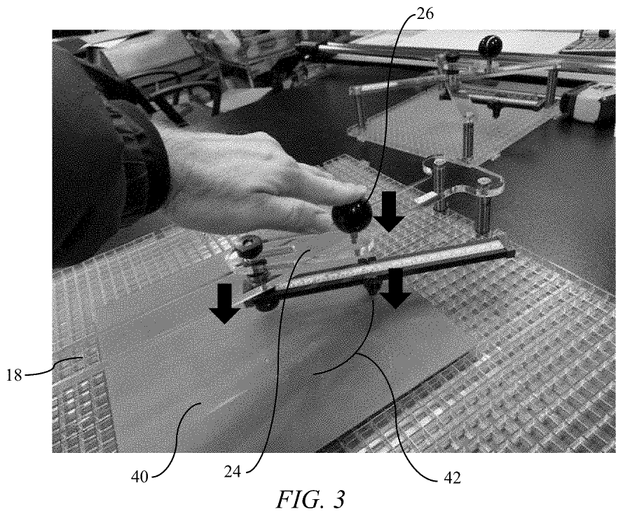

Preferably, as noted above, because the bridging element 18 has an amount of flex, it acts as a leaf spring, allowing a user to etch the etch-line 42 more deeply into the glass pane 40. As shown in FIG. 3, a user may press down on the gripping element 26 at the same time he or she rotates the handle 24. Pressing down on the gripping element 26 effectively flexes the bridging element 18 at the midpoint 20 thereof, causing the arm 28 and, ultimately, the etching element 32 to be pressed more significantly into the glass pane 40, as illustrated in FIG. 3. Thus, because the handle 24 and the arm 28 are rigidly held to the axis 22, the full amount of pressure from the user on the gripping element 26 may be translated and exerted on the etching element 32 as it etches the glass pane 40, providing a relatively deeper etch-line 42.

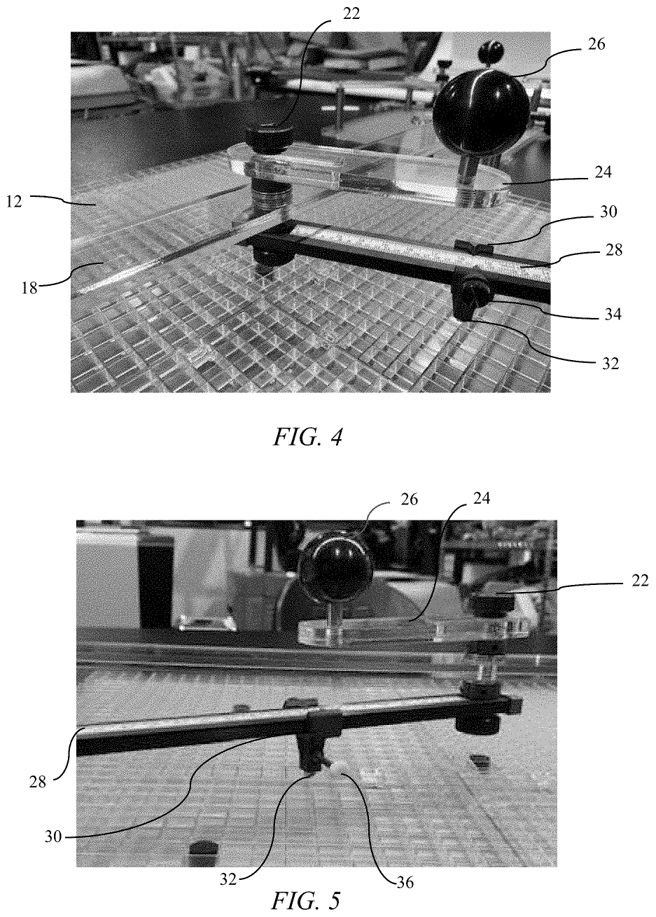

As illustrated in FIG. 4, the arm 28 may have measurements thereon so that a user may precisely place the carriage 30 and, thus, the etching element 32, into a desired position so that the user knows the precise distance from the axis 22, or the radius, of the arcuate etch-line 42. A tightening dial 34 on a side of the carriage 30 may be tightened when the carriage is in a desired position on the arm 28 or loosened when a user wishes to move the carriage 30 and, thus, the etching element 32. Generally, the carriage 30 may be placed in any desired position on the arm 28. If the carriage 30 is placed closer to the axis 22, then the arcuate etch-line 42 will have a smaller radius and therefore a tighter arc, whereas if the carriage 30 is placed away from the axis 22, then the arcuate etch-line will be a larger radius.

As illustrated in FIG. 5, the etching element 32 may be positioned vertically as desired. Preferably, after a user placed a glass pane therebeneath, the etching element 32 may be positioned vertically to contact the top surface of the glass pane so that the glass pane may be etched by the etching element 32. A tightening dial 36 may be used for the purpose of loosening the etching element 32 and moving it vertically up or down, and may be tightened when the etching element 32 is in its desired position.

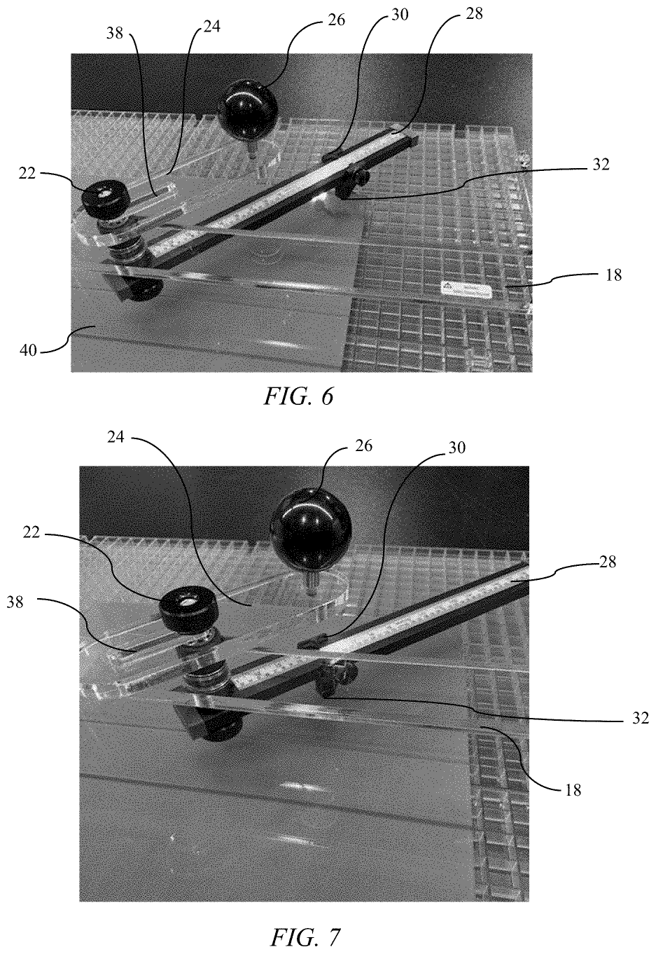

As shown in FIGS. 6 and 7, the handle 24 may have a slot 38 therein that allows the distance between the axis 22 and the gripping element 26 to be lengthened (as shown in FIG. 5) or shortened (as shown in FIG. 6) by sliding the axis 22 within the slot 38 and tightening the handle at a desired location. By lengthening the handle 24 as shown in FIG. 5, the gripping element 26 may be extended away from the axis 22, which may provide more downward torque when a user presses the same while rotating and etching the glass pane 40. Therefore, if the carriage 30 and the etching element 32 are positioned a relatively large distance away from the axis 22 to etch a relatively large radius etch-line 42, as shown in FIG. 5, lengthening the handle 24 may allow more downward torque and, therefore, more pressure to be exerted on the etching element 32 to provide a deeper etch-line 42 on the glass pane. Likewise, if the carriage 30 and the etching element 32 are positioned relatively near the axis 22, as shown in FIG. 6, thereby providing an etch-line 42 that has a relatively small radius, shortening the handle 24 may allow less downward torque so that the apparatus retains its stability when etching the glass pane 40, without danger of tipping over or the like caused by the increased downward torque on the handle 24.

Alternate embodiments of the present invention include different carriages that may be utilized in place of a carriage with a glass etching element thereon, as described herein. Specifically, in an alternate embodiment, a carriage may include a marking element, such as an ink marker or the like that may be used to provide an arcuate or circular marking in a planar material. Specifically, a marker may extend from a carriage, which may be positioned to contact a flat material, such as glass, paper, cardboard, wood, plastic, or any other material apparent to one of ordinary skill in the art. As the user rotates the handle, the marker may mark an arcuate line on the flat material. Likewise, the carriage may contain a blade or other like cutting element which may be used to cut the flat material therebeneath, which may be made from a material other than glass, such as paper, cardboard, plastic sheet or film, or other like material. It should be noted that any tool may be mounted on a carriage where it is desired that the tool provide a transformation of the flat material positioned therebeneath in an arcuate or circular manner.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. An arcuate or circular cutting apparatus comprising:
a base comprising a plurality of cells in a grid arrangement;
a first leg extending from the base;
a second leg extending from the base; and
a bridging element spanning from the first leg to the second leg;
an axis disposed perpendicularly through the bridging element at about a midpoint of the bridging element;
a handle rotatably connected to the axis over the bridging element; and
an arm extending from the axis beneath the bridging element, the arm comprising a carriage thereon having a glass etching element disposed beneath the carriage, the glass etching element configured to etch a glass pane positioned beneath the glass etching element on the base.
